(19) United States
(12) Patent Application Publication
(10) Pub. No.: US 2026/0008281 A1
(43) Pub. Date: Jan. 8, 2026

(54) TRANSPORT DEVICE FOR TRANSPORTING SUBSTRATES

(71) Applicant: Phoenix Contact GmbH & Co. KG, Blomberg (DE)

(72) Inventors: Jürgen GRETSCHER, Dornhan (DE); Meinrad KEMPTER, Öhningen (DE); Michael PETER, Lage (DE); Kilian KLAGES, Detmold (DE); Michael ESSLINGER, Rottweil (DE)

(21) Appl. No.: 19/135,084

(22) PCT Filed: Nov. 17, 2023
(86) PCT No.: PCT/EP2023/082192

§ 371 Date: Jul. 30, 2025

(30) Foreign Application Priority Data
Dec. 7, 2022 (DE) 10 2022 213 235.1

(51) Int. Cl. B41J 13/08; B41J 13/10

(52) U.S. Cl. CPC B41J 13/08; B41J 13/10

(57) ABSTRACT

A transport device for transporting substrates includes: a frame; two guides fastened to or formed on the frame, the two guides extending in an elongate manner in a transport direction and being spaced apart from one another in a lateral direction, in the lateral direction, a first guide of the two guides being a fixed bearing and a second guide of the two guides being a floating bearing; and a drive by which a substrate mounted on the two guides is displaceable along the two guides.

### CROSS-REFERENCE TO PRIOR APPLICATIONS

This application is a U.S. National Phase application under 35 U.S.C. § 371 of International Application No. PCT/EP2023/082192, filed on Nov. 17, 2023, and claims benefit to German Patent Application No. DE 10 2022 213 235.1, filed on Dec. 7, 2022. The International Application was published in German on Jun. 13, 2024 as WO/2024/120800 under PCT Article 21(2).

### FIELD

The invention relates to a transport device for transporting substrates, a printing system comprising a transport device of this kind, and a method for transporting substrates.

### BACKGROUND

Substrates to be processed, in particular in the form of printing media to be printed by a printer, are typically transported in succession to the printer. Various possibilities are known for this.

WO 2020/174017 A1 describes, for example, conveying of substrates in the form of marker cards to a printer by means of round belts.

However, such round belts typically have a relatively high degree of elasticity. Furthermore, the round belts can slip with respect to drive rollers and also the substrates can slip relative to the round belt. As a result, it is difficult, with such transport devices, to ensure exact positioning of the substrates in the printer, and therefore the printing quality may be limited. Variations in the dimensions of the substrates due to manufacturing-related tolerances may further intensify these problems.

DE 10 2007 011 179 A1 describes a central guide centrally on a substrate. As a result, an additional orientation by means of outer positioning pins is necessary in the printing region, which requires a complex mechanism. Even small tolerance-related deviations in the dimensions of the substrate from an ideal structural shape can result in the positioning pins miss holes in the substrate, which can lead to errors in the printing process.

### SUMMARY

In an embodiment, the present invention provides a transport device for transporting substrates, comprising: a frame; two guides fastened to or formed on the frame, the two guides extending in an elongate manner in a transport direction and being spaced apart from one another in a lateral direction, in the lateral direction, a first guide of the two guides comprising a fixed bearing and a second guide of the two guides comprising a floating bearing; and a drive by which a substrate mounted on the two guides is displaceable along the two guides.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a printing system for printing substrates in the form of printing media;

FIG. 2 is a view of a printing medium in the form of a plate mat having a plurality of identification plates breaking out;

FIGS. 3 to 7 are various views of a transport device of the printing system according to FIG. 1;

FIG. 8 is a detail view of a guide of the transport device according to FIGS. 3 to 7 that forms a fixed bearing, with a printing medium placed thereon; and

FIG. 9 is a detail view of a guide of a printing medium placed on the transport device according to FIGS. 3 to 7 under a hold-down element of a positioning means.

### DETAILED DESCRIPTION

In an embodiment, the present invention improves the accuracy of transport of substrates in a simple manner.

According thereto, a transport device for transporting substrates comprises a frame, two guides that are fastened to or formed on the frame, extend in an elongate manner in a transport direction and are spaced apart from one another in a lateral direction, wherein, with regard to the lateral direction, one of the guides forms a fixed bearing and the other of the guides forms a floating bearing, and a drive by means of which a substrate mounted on the guides can be displaced along the guides and thus along the transport direction.

This embodiment allows for the substrates, which may be printable printing media, to be transported along the transport direction in a securely supported manner and at the same time to be accurately positioned in the lateral direction, wherein the floating bearing on one side can itself compensate comparatively large manufacturing tolerances. Thus, an accurate and reproducible positioning of flat substrates under for example a printing means can be ensured, also taking account of comparatively large tolerances of the transported substrates and associated deviations from the ideal structural shape. Furthermore, the thus improved accuracy of the transport of substrates can be achieved with a particularly simple construction, which for example does not require any positioning pins that are to be inserted perpendicularly to the transport direction. Furthermore, a carriage that receives the substrate is not required, and therefore the moved mass can be kept low. As a result, only at most slight oscillations are generated by the displacement, which allows a particularly good, printed image quality, as well as also more dynamic positioning with simultaneously low energy consumption.

The transport device can comprise a positioning means for positioning a substrate mounted on the guides, e.g. in the lateral direction and/or in a height direction perpendicular thereto. This can further improve the accuracy of the positioning. In this case, e.g. orientation to the guide forming the fixed bearing takes place. For example, a printer is arranged on the positioning means.

For example, the positioning means comprises a hold-down element that is arranged on one of the guides and is oriented obliquely to the lateral direction. The oblique orientation makes it possible to establish a line contact with a transported substrate. This allows for precise positioning both in the lateral direction and in a height direction, and at the same time makes it possible to prevent smudging of printing ink.

Optionally, an obliquely extending mounting surface for mounting the hold-down element is formed on the frame. This allows for direct attachment of the hold-down element with few components.

The at least one hold-down element can comprise a lead-in chamfer. This makes it possible for also curved or twisted substrates to be transported reliably, without jamming.

The obliquely oriented hold-down element can be arranged on the guide that forms the fixed bearing. This allows for particularly precise positioning.

The positioning means optionally comprises a hold-down element that is arranged on the guide that forms the floating bearing and/or is oriented in parallel with the lateral direction. As a result, the substrate can be transported and positioned precisely, wherein even large manufacturing tolerances can be compensated.

The guide forming the fixed bearing can comprise a guide rail. The guide rail can extend over a height perpendicularly to the transport direction and perpendicularly to the lateral direction. The substrate can sit and be reliably guided on said guide rail.

The guide rail optionally has an acutely tapering portion in cross-section. This makes it possible to ensure that even substrates produced with significant inaccuracies can be placed correctly on the guides.

The guide that forms the floating bearing can be configured as a flat guide surface. Such an embodiment is particularly easy to produce and robust, and furthermore allows for compensation of larger tolerances.

Optionally, the frame is configured in the form of an extruded profile. This allows for particularly simple production. The pressing direction corresponds e.g. to the transport direction.

The frame can be formed in one piece, in particular of one material. This allows for simple production of the transport device as well as a robust and reliable configuration.

The frame optionally comprises one or more drive guides for the drive. Thus, the frame can fulfil a plurality of functions simultaneously, such that in particular few components are required.

For example, the drive comprises a slide. The slide can be configured to push a substrate mounted on the guides, e.g. at a rear end face. This allows for a particularly reliable transport movement.

At least one substrate in the form of a plate mat, e.g. having a plurality of identification plates breaking out, can be mounted on the guides. The substrate can be flat. The substrate can furthermore be rigid.

According to one aspect, a printing system is provided. The printing system comprises a printer. Furthermore, the printing system comprises the transport device according to any embodiment described herein for transporting substrates to the printer and/or away from the printer. With regard to the advantages, reference is made to the above statements regarding the transport device.

According to one aspect, a method for transporting a substrate using a transport device according to any desired embodiment described herein is specified. The method comprises the following steps: arranging a substrate on the guides; and activating the drive for displacing the substrate along the guides. With regard to the advantages, reference is again made to the above statements regarding the transport device.

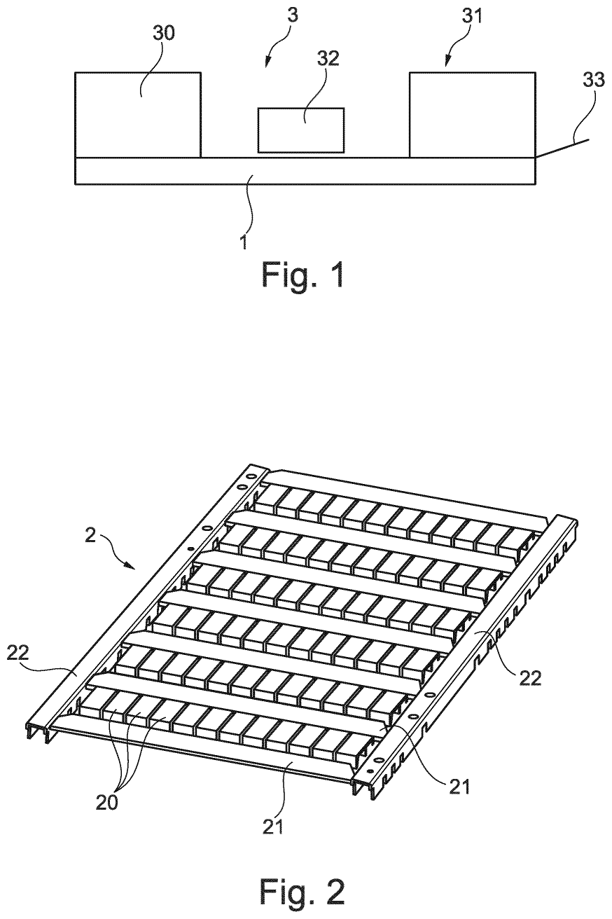

FIG. 1 shows a printing system 3 for printing a plurality of individually printable substrates in the form of printing media. For this purpose, the printing system 3 comprises a separating device 30, into which a stack of printing media can be input automatically or manually. A transport device 1 conveys individual printing media, output from the separating device 30, to a printer 32 of the printing system 3.

The printer 32 prints the individual printing media in succession. From the printer 32, the printing media are conveyed by means of the transport device I to a stacking device 31. The stacking device 31 stacks the individually printed printing media to form a stack, which can then be removed manually or automatically from the stacking device 31. Alternatively, individual printing media can be output by means of the transport device 1 at a separate output 33.

FIG. 2 shows an example of a printing medium 2 of this kind. The printing medium 2 comprises a plurality of identification plates 20. The identification plates 20 are in each case molded on (at least) one of a plurality of webs 21. The webs 21 are arranged between two pairs of runners 22 serving as guides, so as to be parallel with one another and with the identification plates 20. In this case, the webs 21 are in each case fixed on the runners 22. The printing medium 2 is formed in one piece. It is for example an injection-molded part. In particular, the printing medium 2 can consist of a plastics material or comprise a plastics material. The individual identification plates 20 can be broken off the webs 21. Thus, an identification plate 20 printed by the printer 32 can be attached e.g. to an electrical or electronic component, in order to identify it. For this purpose, the identification plates 20 each comprise latching elements for latching to a respective component.

The printing medium 2 can also be referred to as a pad or card. It is plate-shaped and rigid. Due to the dead weight of the printing medium 2, the printing medium 2 does not bend or bends only insignificantly, i.e. for example if it is held only at one side or corner.

The printing medium 2 has a length, a width and a height. The height is smaller than the length and the width. The width is smaller than the length. The guides 22 extend along the length. The end faces of the printing medium 2 extend over its width.

Depending on the required shape and size of the identification plates 20, the printing medium 2 can have a larger or smaller number of identification plates 20 and webs 21 for holding the identification plates 20.

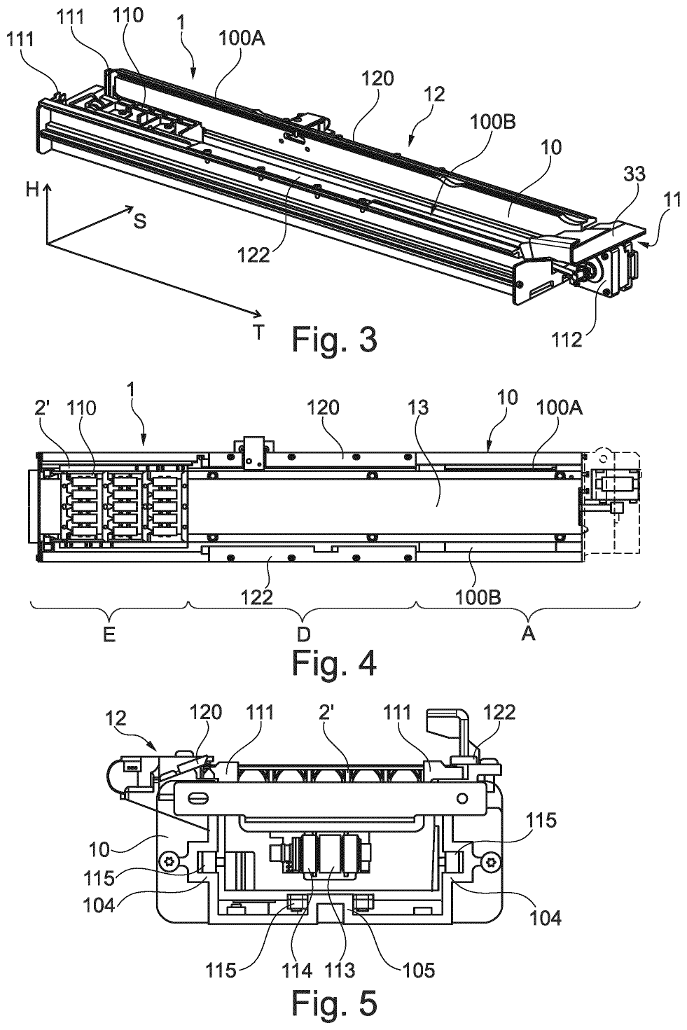

FIGS. 3 to 7 show the transport device 1 and its mode of operation.

The transport device 1 comprises a frame 10, a drive 11 and a positioning means 12.

The frame 10 is formed in one piece, in the present case as an extruded profile. For example, the frame is produced from aluminum or comprises aluminum. The frame 10 is elongate and has a long side. The frame 10 has the same cross-sectional shape at different (optionally all) points along the long side. Extruded profiles can be configured so as to be particularly stable and robust.

The transport device 1 comprises two guides 100A, 100B that extend in an elongate manner in a transport direction T and are spaced apart from one another in a lateral direction S perpendicular to the transport direction T. In general, the guides 100A, 100B can be fastened or formed on the frame 10. In the example show, the guides 100A, 100B are formed on the frame 10, and in the present case constitute a part of the frame 10.

The frame 10 comprises a base from which two lateral surfaces extend. The lateral surfaces are arranged in parallel with one another. In each case one of the guides 100A, 100B is formed at the respective open end of the lateral surfaces. The frame 10 therefore has a generally U-shaped cross-section. The frame 10 forms a trough.

With respect to the lateral direction S, one of the guides 100A (the guide 100A shown on the left in FIG. 7) forms a fixed bearing. Said guide 100A therefore prevents a movement (beyond tolerances) of a printing medium 2′, deposited thereon, in the lateral direction S. A movement of the printing medium 2′, deposited thereon, in the lateral direction S is restricted or entirely prevented by the fixed bearing. A movement of the printing medium 2′ along the transport direction T is enabled (and guided by the guide 100A).

The guide 100A forming the fixed bearing comprises a guide rail 102. The guide rail 102 extends along the transport direction T. The guide rail 102 has a width along the lateral direction S and a height along a height direction H perpendicular to the lateral direction S and to the transport direction T. A pair of runners 22 of the printing medium 2′ surrounds the guide rail 102. The printing medium 2′ can be deposited on the transport device 1 in such a way that the guide rail 102 is arranged between two runners 22 of the printing medium 2′.

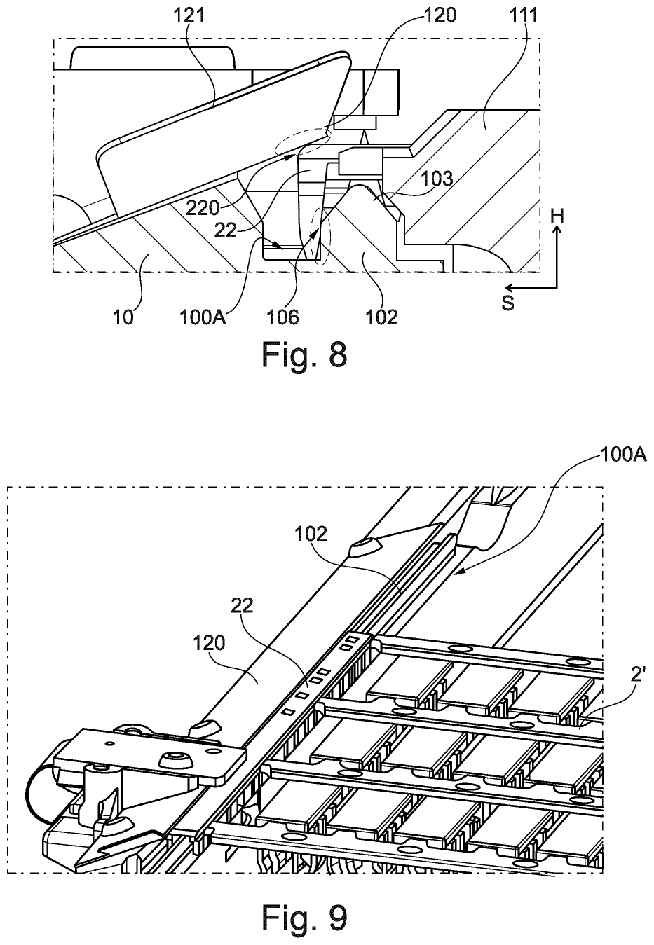

As can be seen for example from FIGS. 7 and 8, the guide rail 102 comprises a portion 103 that tapers acutely in cross-section. The acutely tapering portion 103 is formed by two surfaces of the guide rail 102 that extend at an angle relative to one another. This facilitates the placement of the printing medium 2′.

Furthermore, the guide rail 102 comprises a lateral edge 106, in the present case two such edges 106, from which the acutely tapering portion 103 proceeds.

The fixed bearing is rigid. It does not yield laterally, even during acceleration and during braking. This prevents an oscillation, which allows for improvements in the printing quality, reproducibility and debounce time.

In the present case, the positioning means 12 comprises two hold-down elements 120, 122, in each case in the form of a hold-down plate. The hold-down element 120 on the guide 100A that forms the fixed bearing extends obliquely to the guides 100A, 100B. In the present case, the hold-down element 120 is oriented at an angle to the plane spanned by the transport direction T and the lateral direction S. As can be seen in particular from FIG. 8, the hold-down element 120 rests on the printing medium 2′ when this is located on the positioning means 12. In this case, the hold-down element 120 contacts the printing medium 2′ at a curvature 220 of an edge of the printing medium 2′. In this case there is linear contact, highlighted by an oval in FIG. 8. This allows for sliding along without jamming, does not impede the printing process, and allows for precise positioning. In this case, a force is introduced obliquely, having a component downwards along the height direction H and a component along the lateral direction counter to the printing medium 2′. In this case, the hold-down element 120 presses a runner 22 of the printing medium 2′ against the guide rail 102, specifically against an edge 106 of the guide rail 102. As a result there is linear contact there too (again highlighted by an oval in FIG. 8).

The positioning means 12 thus serves for positioning the substrate 2′ mounted on the guides 100A, 100B in the lateral direction S and in the height direction H perpendicular thereto.

A lead-in chamfer 121 of the hold-down element 120 allows for reliable insertion even in the case of curved printing media 2′.

The hold-down element 120 is mounted directly on the frame 10, in the present case screwed thereon, and specifically on an obliquely formed mounting surface 101 of the frame 10.

The other of the guides 100B (specifically the guide 100B shown e.g. on the right in FIG. 7) forms a floating bearing. This guide 100B therefore allows for a free movement of the printing medium 2′ deposited thereon, both along the transport direction T and along the lateral direction S. In the present case, the guide 100B that forms the floating bearing is configured as a planar guide surface, which in the example shown extends in a plane spanned by the transport direction T and the lateral direction S.

The combination of the fixed bearing and floating bearing means that large variations in the width (along the lateral direction S) of the printing media 2′ can be tolerated. The printing media 2′ are always positioned precisely on the fixed bearing and are reliably supported and mounted by the two guides 100A, 100B.

The positioning means 12 further comprises a hold-down element 122 that is arranged on the guide 100B that forms the floating bearing and is oriented in parallel with the lateral direction S. Said hold-down element 122 thus extends in a plane spanned by the transport direction T and the lateral direction S. It extends in parallel with the planar guide surface of the guide 100B.

The hold-down element 122 of the guide 100B that forms the floating bearing also comprises a lead-in chamfer 123 for the printing medium 2′.

In the present case, the positioning means 12 is arranged in a printing region D, as can be seen in particular from FIG. 4. In the mounted state, the printer 23 is arranged in the printing region D. The printing region D is arranged between an input region E and an output region A. Printing media 2′ for printing on the transport device I can be deposited in the input region E. The printed printing media 2′ can be removed from the transport device 1 in the output region A. This takes place in the mounted state by means of the separating device 30 and the stacking device 31.

The hold-down elements 120, 122 allows for printing of the runners 22, and a continuously well positioned guide over the complete printing region D is also achieved. This allows for particularly good printing results.

By means of the drive 11, the printing medium 2′ mounted on the guides 100A, 100B is displaceable along the guides 100A, 100B and thus in the transport direction T. The drive comprises a slide 110 which is displaceable relative to the frame 10. For this purpose, the frame 10 comprises a plurality of drive guides 104, 105. Two drive guides 104 are formed on the opposing lateral surfaces of the frame 10. Furthermore, a drive guide 105 is formed on the base of the frame 10. Guide rollers 115 of the slide 110 are guided on the drive guides 104, 105 along the transport direction T.

The drive 11 comprises a motor 112. In the present case, the motor 112 is fastened to a long-side end of the frame 10, specifically to an end plate 15 fastened to the end of the frame 10. The motor 112 drives a belt 113 that extends along the transport direction T. The belt 113 is guided around a roller 114 which is rotatably mounted on an end plate 14. Said end plate 14 is fastened to the frame 10 at the end of the frame 10 opposite the motor 112. The slide 110 is e.g. fastened to the belt 113 and can be displaced back and forth along the transport direction T by activation of the drive 11, i.e. in this case consequently by an activation of the motor 112.

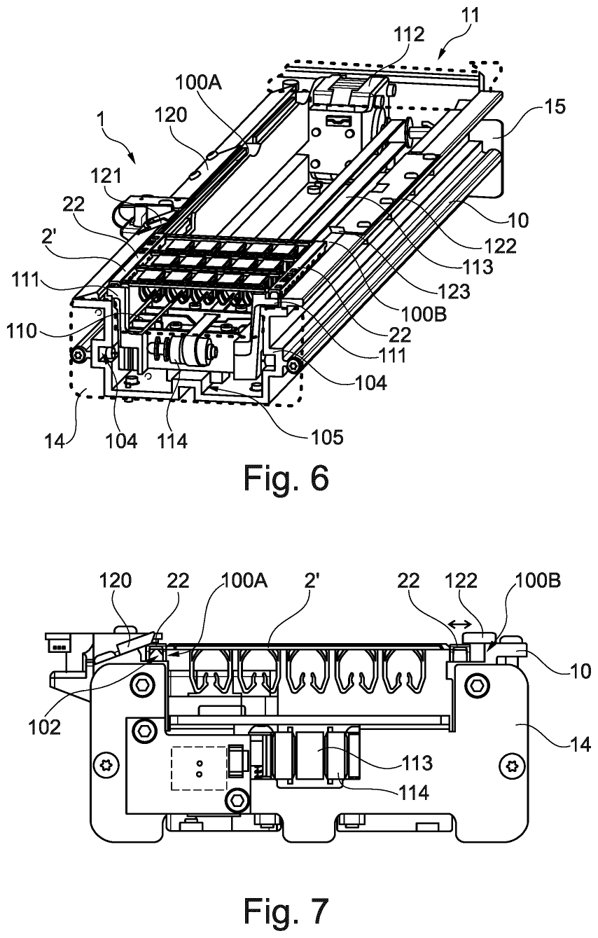

The slide 110 is configured to push the printing medium 2′ mounted on the guides 100A, 100B along the transport direction T. For this purpose, the slide 110 comprises at least one, here two, arms 111, which press against the printing medium 2′ in the case of activation of the motor 112 (see e.g. FIG. 6). In this case, the arms 111 each contact the printing medium 2′ at a corner. As a result, the slide 110 acts on the later runners 22 in such a way that bending of the printing medium 2′ as a result of the drive can be prevented.

An optional cover 13 covers the belt 113 and parts of the slide 110 and thus protects them. The arms 111 of the slide 110 extend past the cover 13 through lateral slits.

The described transport device 1 allows for compensation of the production tolerances of the printing media 2; 2′, already beginning with the deposition on the transport device 1.

The method for transporting a substrate 2; 2′ with the transport device 1 comprises the following steps: arranging the substrate 2; 2′ on the guides 100A, 100B; and activating the drive 11 for displacing the substrate 2; 2′ along the guides 100A, 100B in the transport direction T.

The concept on which the invention is based is not limited to the embodiments set out above, but rather can in principle also be implemented in an entirely different manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 transport device
10 frame
100A, 100B guide
101 mounting surface
102 guide rail
103 portion
104, 105 drive guide
106 edge
11 drive
110 slide
111 arm
112 motor
113 belt
114 roller
115 guide roller
12 positioning means
120 hold-down element
121 lead-in chamfer
122 hold-down element
123 lead-in chamfer
13 cover
14, 15 end plate
2; 2′ printing medium (substrate)
20 identification plate
21 web
22 runner
220 curvature
3 printing system
30 separating device
31 stacking device
32 printer
33 output
A output region
D printing region
E input region
H height direction
S lateral direction
T transport direction

1. A transport device for transporting substrates comprising:
a frame;
two guides fastened to or formed on the frame, the two guides extending in an elongate manner in a transport direction and being spaced apart from one another in a lateral direction, in the lateral direction, a first guide of the two guides comprising a fixed bearing and a second guide of the two guides comprising a floating bearing; and
a drive by which a substrate mounted on the two guides is displaceable along the two guides.

2. The transport device of claim 1, further comprising:
a positioning means for positioning a substrate mounted on the two guides in the lateral direction and/or in a height direction perpendicular thereto.

3. The transport device of claim 2, wherein the positioning means comprise a hold-down element that is arranged on one guide of the two guides and is oriented obliquely to the lateral direction.

4. The transport device of claim 3, wherein an obliquely extending mounting surface for mounting the hold-down element is formed on the frame.

5. The transport device of claim 3, wherein the at least one hold-down element comprises a lead-in chamfer.

6. The transport device of claim 3, wherein the obliquely oriented hold-down element is arranged on the first guide.

7. The transport device of claim 2, wherein the positioning means comprises a hold-down element that is arranged on the second guide bearing and is oriented in parallel with the lateral direction.

8. The transport device of claim 1, wherein the first guide comprises a guide rail which extends over a height perpendicular to the transport direction and to the lateral direction.

9. The transport device of claim 8, wherein the guide rail has an acutely tapering portion in cross-section.

10. The transport device of claim 1, wherein the second guide comprises as a flat guide surface.

11. The transport device of claim 1, wherein the frame comprises an extruded profile.

12. The transport device of claim 1, wherein the frame is formed in one piece.

13. The transport device of claim 1, wherein the frame comprises at least one drive guide for the drive.

14. The transport device of claim 1, wherein the drive comprises a slide configured for pushing the substrate.

15. The transport device of claim 1, wherein the substrate comprises plate mat having a plurality of identification plates breaking out.

16. A printing system, comprising:
a printer; and
the transport device of claim 1 for transporting substrates to the printer and/or away from the printer.

17. A method for transporting a substrate with the transport device of claim 1, the method comprising:
arranging athe substrate on the two guides; and
activating the drive for displacing the substrate along the two guides.
